(19) United States
(12) Patent Application Publication
(10) Pub. No.: US 2006/0177353 A1
(43) Pub. Date: Aug. 10, 2006

(54) Method and apparatus for bead removal

(76) Inventor: Stephen Robert Bysouth, Houston, TX (US)

Correspondence Address: MILES & STOCKBRIDGE PC, 1751 PINNACLE DRIVE, SUITE 500, MCLEAN, VA, 22102-3833, US

(21) Appl. No.: 11/350,859

(22) Filed: Feb. 10, 2006

Related U.S. Application Data
(60) Provisional application No. 60/651,224, filed on Feb. 10, 2005.

(51) Int. Cl. B01L 3/02

(52) U.S. Cl. 422/100

(57) ABSTRACT

The invention is a device and method for separating liquids from solid particles in a laboratory. The device consists of a pipette tip, which has holes or slots arranged radially around the axis of the tip and the lower end of the tip, closed. The smallest dimension of the hole or slit is smaller than the diameter of the solid particles from which the liquid is to be separated. These holes or slits are positioned towards the lower end of the tip such that when plunged into a sample, they are below the level of the phase to be extracted. The method comprises mounting the device on a manual or robotic pipettor, plunging the tip into a mixture of solid particles and liquid to be separated, aspirating the liquid and removing the tip with the aspirated liquid, leaving the solid particles behind in the original container.

### RELATED APPLICATION

This patent application claims priority to U.S. Provisional application Ser. No. 60/651,224 filed Feb. 10, 2005, which is incorporated herein by reference in its entirety.

### FIELD OF THE INVENTION

This invention relates generally to a device and method of separating a liquid, emulsion or suspension from solid particles. Specifically the present invention relates to a means to separate solid particles used in comminution, milling, mixing and/or homogenisation techniques from the material that has been processed, especially in automated systems.

### BACKGROUND OF THE INVENTION

Certain formulation techniques require the use of solid particles or beads. After processing a material, such as a mixture of chemicals, to produce a formulation using techniques that result in a processed sample containing solid particles, a need was identified to separate the solid particles from the formulation in order to use, test or analyse the formulation. This was especially challenging in an automated environment, such as a laboratory ‘High Throughput’ formulation preparation system, where the sample quantity is often limited. Where the solid material is a magnetic bead, electromagnetic techniques may be used to pull the beads from the formulation. However, when using comminution techniques, it is desirable to use non-magnetic ceramic beads as they minimally contaminate the formulation during processing and improve the processing time because of their hardness and density. Filtration techniques are impractical because the sample size is limited and present significant engineering challenges in an automated system, in themselves.

Pipetting techniques are commonly available on laboratory robotic systems and this technique was tried using standard disposable pipette tips. However, when the bead size was at or greater than the diameter of the entrance hole of the pipette tip, the pipette became blocked by a bead and when the diameter of the beads was less than the diameter of the entrance hole, the beads entered the pipette such that in each of these cases, separation was not possible. The invention described herein provides the chemist with a means of successfully separating beads from a formulation and makes possible the automation of this technique.

### SUMMARY OF THE INVENTION

The invention consists of a specially designed pipette tip and methodology that allows the separation of solid particles or beads from a liquid matrix.

The system enables chemists who produce samples using, for example, wet milling techniques, to separate the solid particles or beads from the processed sample, which can then be carried forward to other steps in their workflow. In addition to providing a means to manually separate the particles from the matrix, the invention allows the separation to be performed in an automated manner using conventional laboratory robots.

It is an object of the present invention to provide a means to separate solid particles or beads from a liquid matrix.

It is a further object of the present invention to provide a means that can be used by automated systems.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced or carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter, which illustrate preferred embodiments of the invention.

### BRIEF DESCRIPTION OF THE DRAWINGS

FIG. 1 illustrates an embodiment of the invention as a pipette tip with round holes and closed bottom.

FIG. 2 illustrates an embodiment of the invention as a pipette tip with slotted sides and closed bottom

FIG. 3 illustrates an embodiment of the invention as a pipette tip with slotted sides and closed bottom, mounted on a robotic pipetting system and aspirating a liquid from a vial containing beads.

### DETAILED DESCRIPTION OF THE INVENTION

A device and methodology is disclosed herein for the separation of solid particles or beads from a liquid mixture. The device consists of a new design of disposable pipette tip with holes or slits in the side Preferably the holes or slits are smaller than the solid particles or beads from which the liquid is to be separated. The device is especially suitable for, but not limited to, use in automated laboratory systems where materials such as viscous suspensions must be separated from ceramic grinding beads.

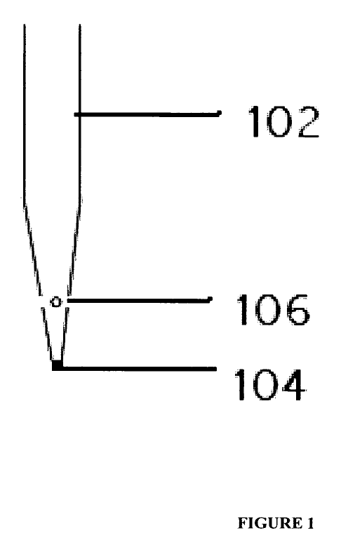

In a first embodiment, FIG. 1, pipette tip 102 has had the normal entrance hole blocked 104 and round holes 106 drilled radially around the tip circumference. In varying embodiments, pipette tip 102 is plastic and/or disposable.

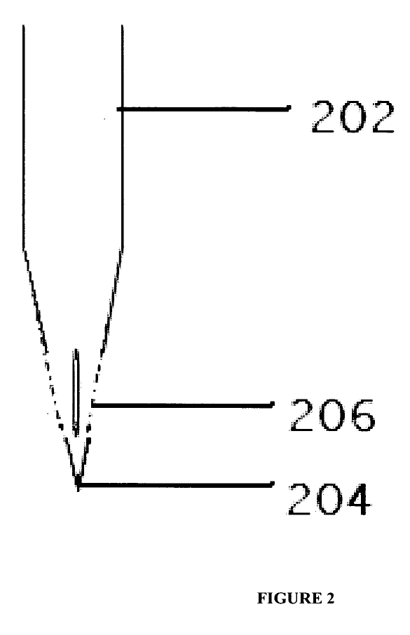

In a second embodiment FIG. 2, pipette tip 202 has had the normal entrance blocked 204 and vertical slits 206 cut radially around the tip circumference. In varying embodiments, pipette tip 202 is plastic and/or disposable.

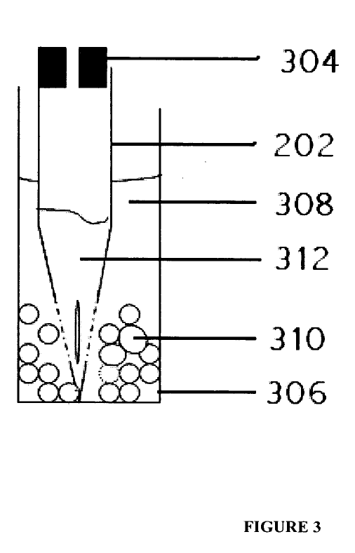

FIG. 3 illustrates a method of use of the second preferred embodiment, where the pipette tip 202 has been mounted on a robotic pipettor 304 and plunged into a vial 306 containing a liquid 308 and beads 310 from which the liquid is being separated by aspiration into the pipette tip at 312.

### Description of Experiments Leading to the Preferred Embodiment and Preferred Methodology

The task was defined as the aspiration of a viscous suspension using disposable tips, from a mixture containing nominally 1 mm diameter zirconia beads. In the first set of experiments, an easily obtainable and relatively harmless household scouring agent was used with water to represent a moderately viscous suspension as the liquid matrix to be separated from the beads. A Hamilton robot was used for process development and to demonstrate automation. For these initial experiments a pipette tip volume of 1000 μl, was used, as this is the size tip available for use on this robot. Alternate pipette tip volumes are contemplated.

### Method

A Hamilton Dual Lab Workstation with a 1000 μl pipettor with disposable tips was used for the first set of experiments. Around 20 ml of a model suspension consisting of 75% Actiff (an abrasive cleaning suspension) and 25% water was shaken by hand with about 5 ml of 1.0 mm diameter zirconia ceramic beads and subsequently vortexed for 20 seconds on a conventional laboratory orbital shaker after which the beads settled quickly to the bottom. The amount of beads was such that a 10 mm layer was present at the bottom of the vial and the suspension layer extended above this to a height of 45 mm from the bottom. During each experiment, 25 transfers of liquid, each of 1000 μl were performed to ensure as much of the 20 ml of suspension used, was transferred.

Both the method of aspiration and the shape of the tip were varied. The tips tested included: the normal 1000 μl tip, various tips with the end cut off at different lengths such that the opening was maximally 4 mm, a tip with a 3 mm opening on which a metal wire mesh was affixed, and two tips with the bottom hole closed off and 4 side holes drilled of 1.2 and 1.0 mm diameter, respectively (see FIG. 1).

### Results of Initial Experiments

For all tests using the normal tips, beads were transferred. The beads were either transferred by being aspirated into the pipette, or were trapped by suction at the entrance to the tip (which also prevented aspiration of the suspension), and deposited in the receiver.

The intent was that, with a larger pipette opening, the beads could be expelled before transfer. However, even with a 20 sec wait period to allow the beads to settle before expulsion, the beads had not settled down and could not be expelled from the tip. This method worked when tested with pure water. When the viscosity of the liquid is high, complete separation was not possible. Additionally, in this experiment it was observed that since the tip was pushed through the bead layer to the bottom of the vial, beads were being pushed into the tip. Positioning the tip above the bead layer but in the suspension might prevent beads from being transferred, though they could still be drawn up from the bottom and not all the available liquid would be removed from the vial.

These pipette tips or methods did not provide a suitable means to separate the beads from the liquid matrix and alternative means had to be sought.

An alternative means was devised to prevent beads from entering the tip, namely a small copper mesh screen with openings of 1˜1.5 mm was placed over a cut-off tip with an opening of 3 mm diameter. Even though this reduced the amount of beads being transferred significantly from the number using the conventional pipette tips, several beads were still transferred. Additionally, manufacture of such a tip would not be economic.

### Experiments using the First Embodiment

In an additional set of experiments, new designs of tip were tested representing examples of the preferred embodiments, each with the normal entrance hole blocked; one with four 1.0 mm holes radially drilled at right angles to the tip axis, 7 mm from the pipette opening and, similarly, another with 1.2 mm holes drilled radially at heights of 4, 7 and 10 mm from the end. Each tip was tested for the transfer of 20 ml of suspension in four consecutive runs (each of 25 aspiration/dispense cycles determined by the 1000 μl tip volume).

### Results Obtained using the First Embodiment

Only for one transfer, were beads transferred (one bead only), using the tip with 1.2 mm holes. As the beads themselves have a nominal diameter of 1.0 mm was determined that one of the smaller beads was aspired through the hole. Reducing the whole diameter to 1.0 mm showed no beads being transferred in 4 consecutive separation experiments. It was concluded that the diameter of the holes should be smaller than any of the beads present in the formulation.

### Experiments using the Second Preferred Embodiment

Finally, examples of a second embodiment was prepared, using tips of large volume (5 ml) which were modified by blocking the normal entrance hole and creating two slots of about 0.8 mm in the sides of the pipette. These were tested using a manual pipettor on formulations of agricultural suspensions that had been comminuted using a bead mill that used beads of the same diameter and composition as in the previous experiments.

### Results Obtained using the Second Preferred Embodiment

This method required slow and controlled aspiration, due to the viscous nature of the formulation. Greater control of aspiration afforded by a robot was demonstrated in the earlier experiments.

Because it is intended that these tips would be used in an automated environment and in cases where the volume of sample in the vial may vary, the aspiration was tested at different heights in the vial, namely, above the beads in the suspension phase and plunged through the beads to the bottom.

In all cases, the tips provided a means to completely separate the formulation from the beads. There was no advantage in terms of separation in plunging the tip though the beads to the bottom of the vial and almost as much formulation could be extracted by holding the tip just at the level of the top of the bead layer. However, in an automated system, the height of this position may not be known or the volume of the liquid processed may be small and in these cases, aspiration from the bottom may be necessary.

### Conclusions

Testing a number of styles of tips has shown that the two embodiments of the invention that use side-holes with hole diameters preferably smaller than the bead diameter or with slits which are preferably narrower than the bead diameter, can be used to cleanly separate and transfer a liquid including a viscous suspension from one vial to another, without transfer of the beads. Additionally, this was demonstrated in an automated system.

It is concluded that a means to separate beads from a liquid formulation has been found. Methods have been devised that allow the means to be applied manually or in an automated environment.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

What is claimed is:

1. A device comprising:
a tube, said tube comprising an upper end having a first opening and a lower end, wherein said tube is narrowed at said lower end to form a tip having a second opening;
an aspiration means, wherein said aspiration means is connectable to said upper end of said tube; and
at least one third opening(s), wherein said third opening(s) are located on said lower end.

2. The device of claim one, wherein said third opening(s) are radially located on said lower end.

3. The device of claim one, wherein said third opening(s) are round or slits.

4. The device of claim one, wherein said device separates solid particles from a liquid and wherein said third opening(s) are smaller than said solid particles.

5. The device of claim one wherein said second opening is blocked or screened.

6. The device of claim one wherein said third opening(s) are located at least two millimeters from said second opening.

7. The device of claim one wherein the device is connectable to a manual pipetting system.

8. The device of claim one wherein the device is connectable to an automated pipetting system.

9. The device of claim one wherein said third opening(s) are arranged radially around said second opening.

10. A method of bead transfer comprising:
mounting a device on a manual or robotic pipettor, said device comprising:
a tube, said tube comprising an upper end having a first opening and a lower end, wherein said tube is narrowed at said lower end to form a tip having a second opening;
an aspiration means, wherein said aspiration means is connectable to said upper end of said tube; and
at least one third opening(s), wherein said third opening(s) are located on said lower end;
plunging said tip into a mixture, wherein said mixture comprises solid(s) and liquid(s), wherein said solid(s) comprises solid particle(s); and
aspirating said liquid.

11. The method of claim ten further comprising:
removing said tip.

12. The method of claim ten, wherein said third tube opening(s) are radially located on said lower end; and wherein said third tube opening(s) are round or slits.

13. The method of claim ten, wherein said third tube opening(s) are smaller than said solid particle(s)

14. The method of claim ten wherein said second opening is blocked or screened.

15. The method of claim ten wherein said third opening(s) are located at least four millimeters from said second opening.

16. The method of claim ten wherein the device is connectable to a manual pipetting system.

17. The method of claim ten wherein the device is connectable to an automated pipetting system.

18. The method of claim ten wherein said third opening(s) are arranged radially around said second opening.

19. A device comprising:
a tube, said tube comprising an upper end having a first opening and a lower end, wherein said tube is narrowed at said lower end to form a tip having a second opening, wherein said second opening is blocked or screened;
an aspiration means, wherein said aspiration means is connectable to said upper end of said tube; and
at least one third opening(s), wherein said third opening(s) are radially located on said lower end, and wherein said third tube opening(s) are round or slits,

20. The device of claim 19, wherein said device separates solid particles from a liquid and wherein said third opening(s) are smaller than said solid particles.
